(19) United States
(12) Patent Application Publication
(10) Pub. No.: US 2021/0086948 A1
(43) Pub. Date: Mar. 25, 2021

(54) Paper-Based Product Transport Package and Continuous Roll of Paper-Based Product Transport Packages

(71) Applicant: Seaman Paper Company of Massachusetts, Inc., Gardner, MA (US)

(72) Inventors: Francesco Pagliani, Correggio (RE) (IT); Chris Jones, Gardner, MA (US)

(21) Appl. No.: 17/026,261

(22) Filed: Sep. 20, 2020

Related U.S. Application Data
(60) Provisional application No. 62/903,481, filed on Sep. 20, 2019.

(51) Int. Cl. B65D 27/16; B31B 70/62; B65D 85/18; B31B 70/64; B31B 160/10; B31B 150/00

(52) U.S. Cl. CPC B65D 27/16; B31B 70/62; B31B 2150/003; B31B 70/64; B31B 2160/102; B65D 85/18

(57) ABSTRACT

An environmentally-friendly alternative to polyethylene garment and other product packages is made of paper, which can be recycled, re-pulped or composted. Each such package includes two parallel coextensive elongated sheets of paper joined together along their respective side edges and along a top edge by heat seal or an adhesive. The two sheets of paper define an expandable volume therebetween. Central portions of the two sheets of paper are separable from each other to increase the volume to accept an article of clothing or other product. Rolls of paper-based product protection material may be manufactured, from which individual packages may be made or cut. Methods and apparatus for manufacturing the product protection material are disclosed.

### CROSS-REFERENCE TO RELATED APPLICATIONS

This application claims the benefit of U.S. Provisional Patent Application No. 62/903,481, filed 20 Sep. 2019, titled “Paper-Based Garment Bag,” the entire contents of which are hereby incorporated by reference herein, for all purposes.

### BACKGROUND

### Technical Field

The present invention relates to transport packages, such as transport packages for garments, produce and other products, and more particularly to paper-based transport packages to reduce use of plastic.

### Related Art

Disposable plastic product transport packages are used to protect products, such as produce and clothing, in several contexts. For example, in many garments manufacturing facilities, after garments are produced, the garments are inserted into garment transport packages, one garment per garment transport package, and the garment transport packages are shipped through a supply chain, such as to distribution centers and on to retail stores or to customers who ordered online. The stores typically display and sell the garments in the garment transport packages. For example, shirts are commonly sold in this way.

In another example, in many garments manufacturing facilities, after garments are produced, the garments are suspended on hangers within garment bags, one garment per garment bag, and the garment bags are suspended in shipping containers (sometimes referred to as “hangtainers”) for transport to distributors or stores. This shipping method is commonly referred to as “garments on hangers” (GOH). In another example, clothing that has been dry cleaned is returned to customers suspended on hangers within garment bags.

Conventional disposable garment transport packages are made of transparent plastic. Transparency of the garment transport packages is important, because consumers typically make purchase decisions based at least in part on color, style, quality and other aspects of a given garment, as visually perceived by the consumer. Since consumers are typically not permitted to remove garments from garment transport packages for inspection before purchasing the garments, garment transport packages that hide or obscure aspects of garments are likely to inhibit consumers from purchasing the garments. Furthermore, to facilitate handling through the supply chain, transparent packages are important, so workers and machines can inspect, control quality and identify package contents, such as automatically optically read bar codes.

Conventional disposable garment bags are made of thin (about 0.5-2.0 mil, 0.0127-0.0508 mm) low-density polyethylene (LDPE, sometimes referred to as “film”) or high-density polyethylene (HDPE) plastic. Although these plastics are recyclable (LDPE is included in Society of the Plastics Industry (SPI) recycling code #2, and HDPE is included in SPI recycling code #4), many recipients of garments in garment bags, particularly GOH garments, do not recycle them, and the plastic ends up in landfills.

Although conventional plastic garment transport packages may be recyclable, manufacturing these plastic garment transport packages consumes large quantities of non-renewable petroleum products. Furthermore, many consumers have difficulty ascertaining whether a given plastic garment transport package is recyclable, because many such packages lack recycling symbols and, in general, the number of types of plastics, some of which are recyclable and others of which are not, cause many consumers to simply discard many or all plastics, rather than sort and recycle them.

A more environmentally friendly transport package, and/or a transport package made from a renewable material, one that is clearly recyclable, is highly desirable. As used herein, the term “garment bag” does not include reusable zippered garment covers, such as garment covers used as luggage or for long-term storage of clothes.

### SUMMARY OF EMBODIMENTS

An embodiment of the present invention provides a product transport package. The product transport package includes a first rectangular sheet and a second rectangular sheet parallel and co-extensive with the first sheet. Each sheet includes paper treated with a substance configured to increase translucency of the paper. Each sheet has: (a) a first longitudinal margin, (b) a second longitudinal margin opposite the first longitudinal margin, (c) a first lateral margin and (d) a second lateral margin opposite the first lateral margin. The two sheets are joined to each other along their respective first and second longitudinal margins by respective first and second joints. The two sheets are further joined to each other along their respective second lateral margins by a third joint. The two sheets and the first, second and third joints thereby define an interior volume therebetween and an opening, along the first lateral margins, into the interior volume.

The product transport package also includes a paper flap. The paper flap is coplanar with, and extends from the first lateral margin of, the second sheet. The paper flap extends to a lateral edge of the flap, distal from the first lateral margin of the second sheet. The flap defines two laterally spaced-apart shoulders. The lateral edge of the flap extends between the shoulders. Each shoulder extends along a respective smoothly-curved line extending tangent from the first lateral margin of the first sheet to the lateral edge of the flap.

The product transport package also includes a re-sealable, pressure-sensitive adhesive disposed on the flap.

The product transport package also includes a paper release strip attached to the flap by the adhesive disposed on the flap.

The entire product transport package is recyclable in a conventional paper recycling process.

Optionally, the first, second and third joints each includes a respective heat seal joint.

In any embodiment in which the first, second and third joints include respective heat seal joints, the first and second sheets include paper treated with a substance configured to increase heat sealability of the paper.

Optionally, the first, second and third joints each includes are respective adhesive joint.

Optionally, in any embodiment, the first and second sheets include paper treated with a substance configured to increase water resistance of the paper.

Optionally, in any embodiment, the first and second sheets include paper treated with a substance configured to increase strength of the paper.

Optionally, in any embodiment, each of the first and second sheets transmits at least about 65-85% of incident light.

Optionally, in any embodiment, the substance configured to increase translucency of the paper includes at least 75% plant-based product.

Optionally, in any embodiment, each of the first and second sheets has a basis weight between about 20 GSM and about 60 GSM.

Optionally, in any embodiment in which the first and second sheets has a basis weight between about 20 GSM and about 60 GSM, each of the first and second sheets includes glassine.

Optionally, in any embodiment, at least one of the two sheets defines a respective hole therethrough proximate a corner of the sheet bounded by the second lateral margin and either the first or the second longitudinal margin. The hole defines a ventilation port between the interior volume and an exterior of the transport package.

Optionally, in any embodiment, at least one of the first, second and third joints defines a gap therein of at least about ¼ inch (6.35 mm). The gap defines a ventilation port between the interior volume and an exterior of the transport package.

Optionally, in any embodiment, each smoothly-curved line is concave, as viewed along the first lateral margin of the first sheet from the other smoothly-curved line.

Optionally, in any embodiment, each joint includes a respective paper gusset. Each gusset includes at least two alternatingly folded pleat panels. One of the two pleat panels is attached to one of the two sheets, and the other of the two pleat panels is attached to the other of the two sheets.

Optionally, in any embodiment that includes a gusset, the two sheets, each gusset and the flap are formed from a single continuous sheet of paper folded to form the gussets and to dispose the two sheets parallel and co-extensive each other.

Optionally, in any embodiment, the entire product transport package includes compostable material.

Optionally, in any embodiment, the entire product transport package includes re-pulpable material.

Optionally, in any embodiment, each joint includes a respective paper gusset. The two sheets, the gussets and the flap each includes at least 50% post-consumer recycled content derived from wood pulp.

Optionally, in any embodiment, each joint includes a respective paper gusset. The two sheets, the gussets and the flap each include glassine having a basis weight between about 20 GSM and about 60 GSM.

Another embodiment of the present invention provides a garment bag. The garment bag has a longitudinal axis. The garment bag includes two parallel coextensive elongated sheets of paper. Each sheet includes paper treated with a substance configured to increase translucency of the paper. Each sheet of paper has two side edges parallel to the longitudinal axis, a bottom edge perpendicular to the longitudinal axis and a top edge. The top edge has a center. The two sheets of paper are joined together along the two side edges and along the top edge by respective joints. One of the joints defines a gap therein proximate the center of the top edge. The gap is configured for protrusion of a clothes hanger hook therethrough. The two sheets of paper define an expandable volume therebetween. Central portions of the two sheets of paper are separable from each other to increase the volume therebetween to accept an article of clothing hung on a clothes hanger. The entire garment bag is recyclable in a conventional paper recycling process.

Optionally, each joint includes a respective heat seal joint.

Optionally, in any embodiment that includes a heat seal, each sheet includes paper treated with a substance configured to increase heat sealability of the paper.

Optionally, in any embodiment, each joint includes a respective adhesive joint.

Optionally, in any embodiment, for each sheet of the two sheets of paper, the top edge is substantially defined by two lines that are symmetric about the longitudinal axis, as viewed normal to the two sheets of paper. Each line extends substantially from the center of the top edge to a respective different one of the side edges and slopes from the center of the top edge toward the bottom edge.

Optionally, in any embodiment, each sheet of the two sheets of paper is between about 10 in. (25.4 cm) and about 40 in. (101.6 cm) wide, as measured perpendicular to the longitudinal axis, and between about 10 in. (25.4 cm) and about 96 in. (243.84 cm) long, as measured parallel to the longitudinal axis.

Optionally, in any embodiment, each sheet of paper includes a recyclable paper.

Optionally, in any embodiment, at least one sheet of the two sheets of paper is coated with a substance configured to increase strength of paper.

Optionally, in any embodiment, at least one sheet of the two sheets of paper is coated with a substance configured to increase water resistance of paper.

Optionally, in any embodiment, at least one sheet of the two sheets of paper is coated with a substance configured to facilitate heat sealability of paper.

Optionally, in any embodiment, each sheet of the two sheets of paper is coated with a substance configured to facilitate heat sealability of paper.

Optionally, in any embodiment, each sheet of the two sheets of paper has a basis weight of about 20-45 GSM.

Yet another embodiment of the present invention provides a product protection material. The product protection material has a longitudinal axis. The product protection material includes two parallel coextensive elongated sheets of paper. Each sheet of paper includes a paper treated with a substance configured to increase translucency of the paper. Each sheet of paper is at least about 600 ft. (182.9 m) long, as measured parallel to the longitudinal axis. Each sheet of paper has two side edges parallel to the longitudinal axis. The two sheets of paper are joined together along the two side edges by respective joints. The two sheets of paper define an expandable volume therebetween. Central portions of the two sheets of paper are separable from each other to increase the volume therebetween to accept a product. The two sheets of paper are wound lengthwise into a roll.

Optionally, each sheet of the two sheets of paper is between about 10 inches (25.4 cm) and about 40 inches (101.6 cm) wide, as measured perpendicular to the longitudinal axis.

Optionally, in any embodiment, each sheet of paper includes a recyclable paper.

Optionally, in any embodiment, at least one sheet of the two sheets of paper is coated with a substance configured to increase tensile strength of paper.

Optionally, in any embodiment, at least one sheet of the two sheets of paper is coated with a substance configured to increase water resistance of paper.

Optionally, in any embodiment, at least one sheet of the two sheets of paper is coated with a substance configured to facilitate heat sealability of paper.

Optionally, in any embodiment, each sheet of the two sheets of paper is coated with a substance configured to facilitate heat sealability of paper.

Optionally, in any embodiment, periodically along the longitudinal axis, the two sheets of paper are joined together along a respective lateral joint line extending generally perpendicular to the longitudinal axis and between the side edges.

Optionally, in any embodiment that includes a lateral joint, the lateral joint line has a center. The joint defines a gap therein proximate the center of the lateral joint line. The gap is configured for protrusion of a clothes hanger hook therethrough.

Optionally, in any embodiment that includes a lateral joint, each lateral joint line extends along two respective lines that are symmetric about the longitudinal axis, as viewed normal to the two sheets of paper. Each line extends substantially from the center of the lateral joint line to a respective different one of the side edges and slopes from the center of the joint adhesive line toward an end of the two sheets of paper.

Optionally, in any embodiment, for each lateral joint line, the two sheets of paper are perforated along a respective tear line proximate the lateral joint line. The tear line extends generally perpendicular to the longitudinal axis and between the side edges.

Optionally, in any embodiment that includes a tear line, the tear lines are spaced apart along the longitudinal axis by about 10 inches (25.4 cm) to about 96 in. (243.84 cm).

An embodiment of the present invention provides a method for manufacturing a product protection material. The product protection material has a longitudinal axis. The method includes providing two parallel coextensive elongated sheets of paper. Each sheet of paper includes paper treated with a substance configured to increase translucency of the paper. Each sheet of paper is at least about 600 ft. (182.9 m) long, as measured parallel to the longitudinal axis. Each sheet of paper has two side edges parallel to the longitudinal axis.

The two sheets of paper are joined together along the two side edges by respective joints. The two sheets of paper define an expandable volume therebetween. Central portions of the two sheets of paper are separable from each other to increase the volume therebetween to accept a product.

The two sheets of paper are wound lengthwise into a roll.

Optionally, providing the two parallel coextensive elongated sheets of paper includes providing a first roll of paper and providing a second roll of paper.

Optionally, in any embodiment, the first roll of paper includes a roll of paper having a basis weight of about 20-45 GSM, and the second roll of paper includes a different roll of paper having a basis weight of about 20-45 GSM.

Optionally, in any embodiment, each sheet of the two sheets of paper is between about 10 inches (25.4 cm) and about 40 inches (101.6 cm) wide, as measured perpendicular to the longitudinal axis.

Optionally, in any embodiment, each sheet of paper includes a recyclable paper.

Optionally, any embodiment may further include coating at least one sheet of the two sheets of paper with a substance configured to increase strength of paper.

Optionally, any embodiment may further include coating at least one sheet of the two sheets of paper with a substance configured to increase water resistance of paper.

Optionally, any embodiment may further include coating at least one sheet of the two sheets of paper with a substance configured to facilitate heat sealability of paper.

Optionally, any embodiment may further include coating each sheet of the two sheets of paper with a substance configured to facilitate heat sealability of paper.

Optionally, in any embodiment, joining the two sheets of paper together includes heat sealing the two sheets of paper together.

Optionally, in any embodiment, joining the two sheets of paper together includes applying an adhesive to at least one of the two sheets of paper.

Optionally, any embodiment may further include periodically, along the longitudinal axis, joining the two sheets of paper together by a joint along a respective lateral joint line extending generally perpendicular to the longitudinal axis and between the side edges. The lateral joint line has a center. The joint defines a gap therein proximate the center of the lateral joint line. The gap is configured for protrusion of a clothes hanger hook therethrough.

Optionally, in any embodiment, each lateral joint line extends along two respective lines that are symmetric about the longitudinal axis, as viewed normal to the two sheets of paper. Each line extends substantially from the center of the lateral joint line to a respective different one of the side edges. Each line slopes from the center of the lateral joint line toward an end of the two sheets of paper.

Optionally, any embodiment may further include for each lateral joint line, perforating the two sheets of paper along a respective tear line proximate the lateral joint line. The tear line extends generally perpendicular to the longitudinal axis and between the side edges.

Optionally, in any embodiment that includes a tear line, perforating the two sheets of paper includes spacing the tear lines apart along the longitudinal axis by about 10 inches (25.4 cm) to about 96 in. (243.84 cm).

### BRIEF DESCRIPTION OF THE DRAWINGS

The invention will be more fully understood by referring to the following Detailed Description of Specific Embodiments in conjunction with the Drawings, of which:

FIG. 1 is a front view of a conventional disposable polyethylene garment bag, according to the prior art.

FIG. 2 is a perspective view of a roll of disposable polyethylene garment bags, according to the prior art.

FIG. 3 is a perspective view of a garment bagger machine, according to the prior art.

FIGS. 4, 5 and 6 are respective front, bottom and perspective views of a garment bag, according to an embodiment of the present invention.

FIG. 7 is a perspective illustration of a method and apparatus for manufacturing a roll of garment protection material, according to respective embodiments of the present invention.

FIG. 8 is a plan view of, i.e., a view normal to a surface of, a portion of one embodiment of the garment protection material manufactured by the method and apparatus of FIG. 7, according to an embodiment of the present invention.

FIG. 9 is a flowchart schematically illustrating a method for manufacturing a garment protection material, according to an embodiment of the present invention.

FIG. 10. is a is a plan view of a portion of an embodiment of a product transport package material manufactured by the method and apparatus of FIG. 7, according to another embodiment of the present invention.

FIG. 11 is a plan view of a portion of an embodiment of a glove manufactured by the method and apparatus of FIG. 7, according to yet another embodiment of the present invention.

FIGS. 12, 13, 14 and 15 are respective top, front, side and front perspective views of a paper-based garment transport package, according to an embodiment of the present invention.

FIG. 16 is a plan view of a single sheet of appropriately cut paper that can be folded to form the paper-based garment transport package of FIGS. 1-4.

FIG. 17 is a side view of a paper-based garment transport package, according to an alternative embodiment of the present invention.

FIG. 18 illustrates three envelopes, according to the prior art.

FIG. 19 illustrates use of the paper-based garment transport package of FIGS. 1-6, according to an embodiment of the present invention.

### DETAILED DESCRIPTION OF SPECIFIC EMBODIMENTS

Embodiments of the present invention provide an environmentally-friendly alternative to polyethylene product transport packages, such as for garments, produce and other products. A product transport package according to embodiments of the present invention is made of paper, which can be recycled, re-pulped or composted. Paper is made from a renewable resource (wood pulp), in contrast with polyethylene, which is made from petroleum. Described herein are individual paper-based product transport packages, rolls of product transport package material, from which individual paper-based product transport packages may be made or cut, and methods and apparatus for manufacturing the product transport package material.

### Conventional Disposable Polyethylene Garment Bags

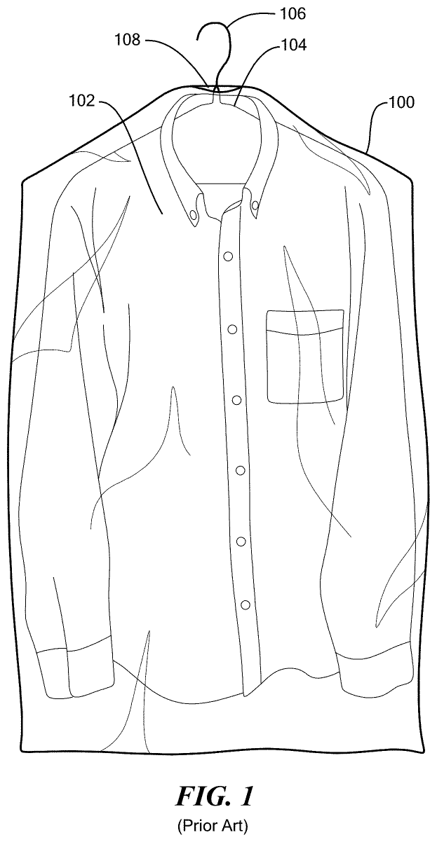

FIG. 1 is a front view of a conventional disposable polyethylene garment bag 100 with a garment 102, in this example a shirt, suspended from a hanger 104 disposed within the garment bag 100. A hook portion 106 of the hanger 104 extends through an aperture 108 defined in a top portion of the garment bag.

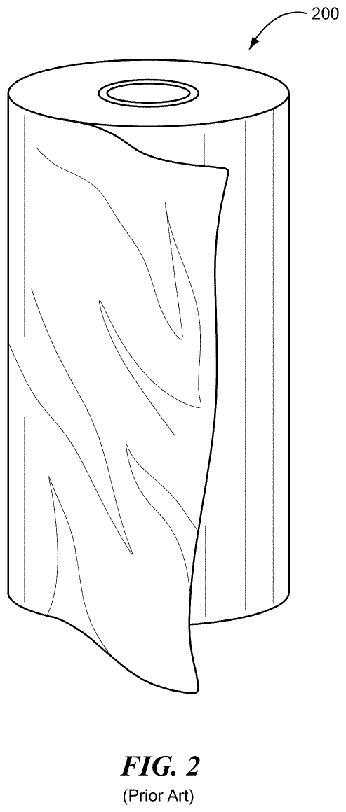

FIG. 2 is a perspective view of a roll 200 of disposable polyethylene garment bags 100, as the garment bags 100 are typically delivered to clothing manufacturers, dry cleaners, etc. A typical roll 200 contains several hundred garment bags 100. Perforations facilitate separating the garment bags 100 from the roll 200, one by one.

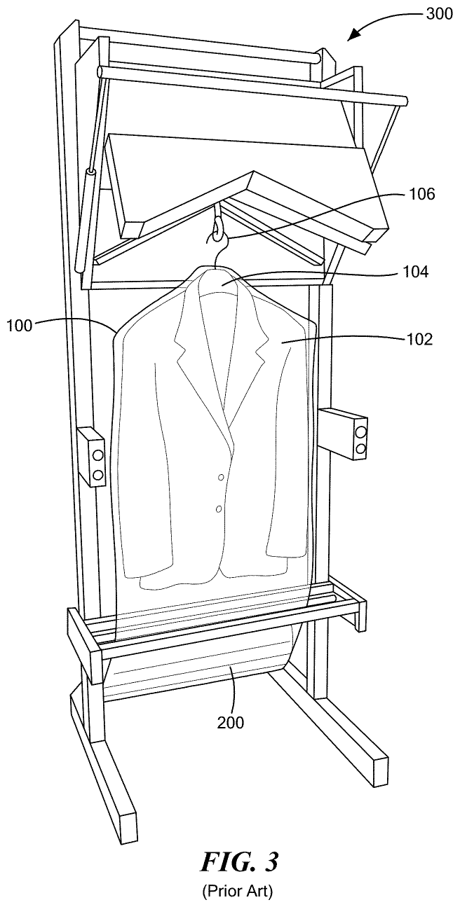

Alternatively, the roll 200 may contain only a continuous “sleeve” of polyethylene, and individual garment bags are made from the roll 200 by a machine, such as a garment bagger 300 shown in FIG. 3. Once the polyethylene sleeve is pulled down from the top of the garment bagger 300, over the hanger 104 and the garment 102, the garment bagger 300 seals, such as by heat, the two sides (front and back) of the sleeve to each other just above the hanger 104 and cuts off the newly-formed garment bag 100 from the sleeve.

An exemplary garment bagger 300 is available as model FPMM/FPMA garment packaging machine from Ferplast, Corso Asti 49/A, 12050 Guarene (Cn) Italy, www.fer-plast.com. Another typical garment bagger 300 is available as model Hawo hp 630 KST garment packing machine from hawo GmbH, Obere Au 2-4, 74847 Obrigheim, Germany, www.hawo.com. The Ferplast and Hawo machines are manually operated. Similar semi-automatic and fully automatic garment packaging machines are also commercially available.

### Paper-Based Garment Bag

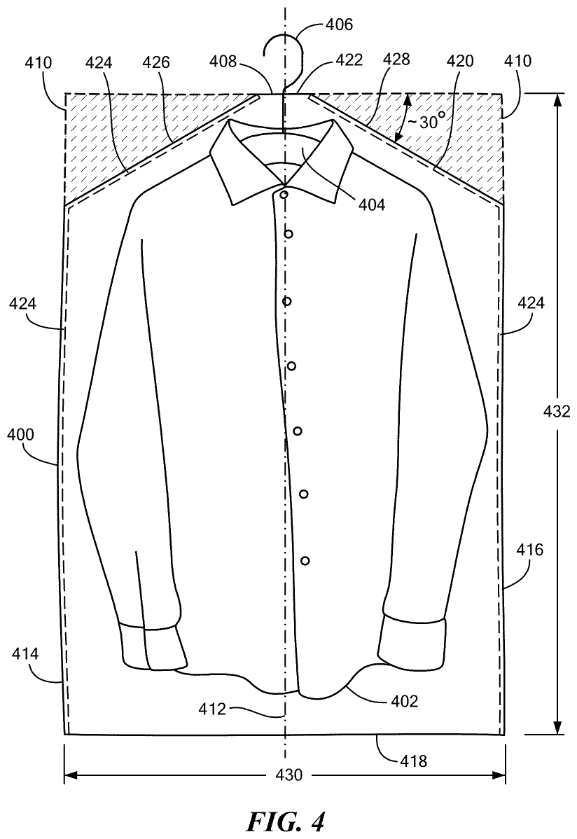

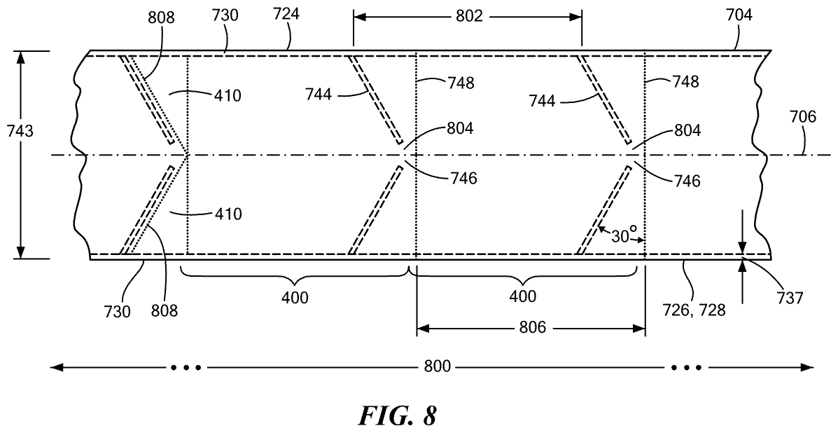

FIGS. 4, 5 and 6 are respective front, bottom and perspective views of a garment bag 400, according to an embodiment of the present invention. FIGS. 4-6 show an article of clothing 402, in this example a shirt, suspended on a clothes hanger 404 and disposed within the garment bag 400. A hook 406 of the cloths hanger 404 extends through an aperture 408 defined by the garment bag 400. Waste material 410 is indicated by dashed lines. This waste material 410 may be removed and discarded, for recycling, during manufacture or use/installation of the garment bag 400. Alternatively, the waste material 410 may remain attached to the garment bag 400, if it is not found to be objectionable. Formation of the waste material 410 is described in more detail herein, with respect to FIG. 8.

The garment bag 400 has a longitudinal axis 412 extending through the aperture 408 and in a direction in which the article of clothing 402 hangs from the hanger 404, i.e., in a direction urged by gravity, if the clothes hanger 404 and article of clothing 402 were suspended in a normal fashion.

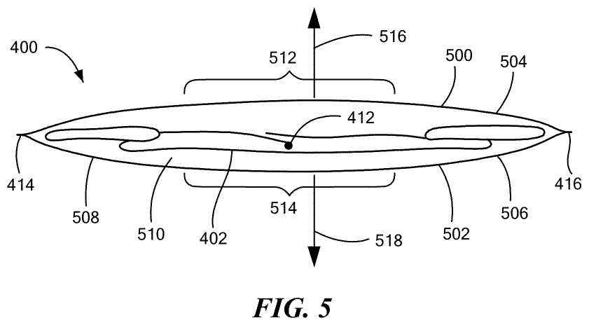

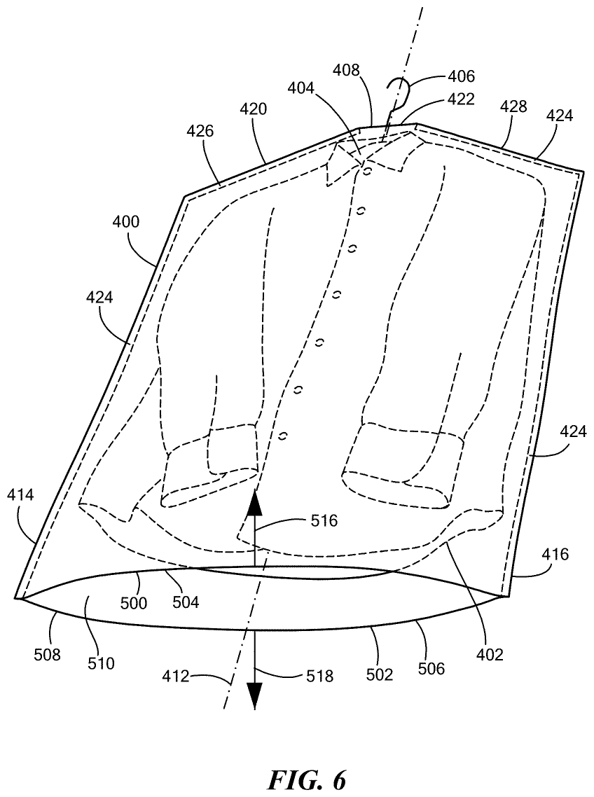

As is most clearly seen in FIGS. 5 and 6, the garment bag 400 includes two parallel coextensive elongated sheets of paper 500 and 502. Each sheet of paper 500 and 502 has two side edges 414 and 416. The two side edges 414 and 416 are parallel to the longitudinal axis 412. The garment bag 400 also has a bottom edge 418 that is perpendicular to the longitudinal axis 412. Thus, each of the two sheets of paper 500 and 502 has a respective bottom edge 504 and 506. The garment bag 400 also has a top edge 420. The top edge 420 has a center 422.

“Coextensive” means the two sheets of paper 500 and 502 have substantially the same width and length dimensions, and one of the sheets of paper 500 registers above the other sheet of paper 502, as viewed normal to the garment bag 400, for example in the view of FIG. 4. Thus, the left side edges 414 of both sheets of paper 500 and 502 register with each other, the right side edges 416 of both sheets of paper 500 and 502 register with each other, the bottom edges 504 and 506 of the two sheets of paper 500 and 502 register with each other, and the top edges 420 of both sheets of paper 500 and 502 register with each other.

The two sheets of paper 500 and 502 are joined together along the two side edges 414 and 416 and along the top edge 420 to form a joint 424. The joint 424 may be made by heat sealing the two sheets of paper 500 and 502 to each other, or by an adhesive. The adhesive may, but need not necessarily, be activated by heat, such as via ultrasonic sealing, as described in more detail herein. Alternatively, a two-part and/or contact adhesive may be used, which may obviate a need for heat activating the adhesive. The joint 424 may be continuous along each side edge 414 and 416, or the joint 424 may be intermittent along the side edges 414 and 416. The joint 424 defines a gap, i.e., the aperture 408, proximate the center 422 of the top edge 420. The gap 408 is configured for protrusion of the clothes hanger hook 406 through the gap 408. Apart from the gap 408, the joint 424 may be continuous along the top edge 420, or the joint 424 may be intermittent along the top edge 420.

As most clearly seen in FIGS. 5 and 6, the bottom edges 504 and 506 collectively form a bottom opening 508, and the two sheets of paper 500 and 502 define an expandable volume 510 between the two sheets of paper 500 and 502. The expandable volume 510 is accessible via the bottom opening 508.

Central portions 512 and 514 of the two sheets of paper 500 and 502 are separable from each other, as indicated by arrows 516 and 518, to increase the volume 510 between the two sheets of paper 500 and 502, to accept the article of clothing 402 hung on the clothes hanger 404. In some embodiments, the central portions 512 and 514 of the two sheets of paper 500 and 502 are separable from each other by about 2 in. (50.8 mm) to about 6 in. (152.4 mm), although in other embodiments the central portions 512 and 514 of the two sheets of paper 500 and 502 are separable from each other by other distances.

In use, the article of clothing 402 and the clothes hanger 404 are inserted through the bottom opening 508, into the expandable volume 510, or the garment bag 400 is pulled over the article of clothing 402 and the clothes hanger 404. Absent the article of clothing 402 and the clothes hanger 404, the garment bag 400 can be essentially flat.

For each sheet 500 and 502 of the two sheets of paper, the top edge 420 (FIG. 4) may be substantially defined by two lines 426 and 428 that are symmetric about the longitudinal axis 412, as viewed normal to the two sheets of paper 500 and 502. Each line 426 and 428 extends substantially from the center 422 of the top edge 420 to a respective different one of the side edges 414 or 416 and slopes from the center 422 of the top edge 420 toward the bottom edge 418. As used in this context, “substantially from the center 422” means from or proximate the center 422, including ending spaced from the center 422 by about half the width of the aperture 408. In some embodiments, the slope of each line 426 and 428 is about 30°, relative to a perpendicular to the longitudinal axis 412. In this context, as used herein, including in the claims, a slope of up to about 45° is considered to be substantially perpendicular or generally perpendicular to the longitudinal axis 412.

The garment bag 400 may be sized to accommodate typical clothing, such as men's, women's or children's shirts, jackets, pants, suits, skirts, coats and the like. For example, each sheet 500 and 502 of the two sheets of paper may be between about 10 in. (25.4 cm) and about 40 in. (101.6 cm) wide 430, as measured perpendicular to the longitudinal axis 412, and between about 10 in. (25.4 cm) and about 96 in. (243.84 cm) long 432, as measured parallel to the longitudinal axis 412.

Each sheet of paper 500 and 502 may be a recyclable paper. Each sheet 500 and 502 of the two sheets of paper may have a basis weight of about 20-45 GSM, although other basis weight papers less than 20 GSM and/or greater than 45 GSM may be used. The two sheets of paper 500 and 502 need not necessarily have the same basis weight.

At least one sheet 500 or 502 of the two sheets of paper may be coated with a substance configured to increase translucency of paper. As noted in Wikipedia, transparency, also called pellucidity or diaphaneity, is a physical property of a material that allows light to pass through the material without being scattered. On a macroscopic scale, i.e., one where the dimensions investigated are much larger than the wavelength of the photons in question, the photons can be said to follow Snell's Law.

Translucency, also called translucence or translucidity, is a physical property of a material that allows light to pass through the material, but does not necessarily, on the macroscopic scale, follow Snell's law. Instead, the photons can be scattered at either of two interfaces with the material, or internally, where there is a change in index of refraction. In other words, a translucent material may be made up of components with different indices of refraction.

A transparent material is made up of components with a uniform index of refraction. Transparent materials appear clear, with the overall appearance of one color, or any combination of colors. As used herein, including in the claims, “translucent” includes “transparent.”

At least one sheet 500 or 502 of the two sheets of paper may be coated with a substance configured to increase tensile and/or burst strength of paper. At least one sheet 500 or 502 of the two sheets of paper may be coated with a substance configured to increase water resistance of paper.

HydraBan® 708 paper coating is a suitable re-pulpable substance that may be coated on one or both of the two sheets of paper 500 and/or 502 to increase strength, water resistance and/or translucency of the sheet of paper 500 and/or 502. HydraBan® 708 paper coating is available from Michelman, Inc., 9080 Shell Road, Cincinnati, Ohio 45236-1299 USA, www.michelman.com. Suitable coatings may also be available from HS Manufacturing Group, 41 Madison Avenue, 31st Floor, New York, N.Y. 10010, www.hsmgrp.com. Other suitable substances may be used instead or in addition.

One or both sheets 500 and/or 502 of the two sheets of paper may be coated with a substance configured to facilitate heat sealability of paper.

Some adhesives are suitable when applied to only one of two surfaces that are to be joined to each other, while other adhesives work best when applied to both surfaces. The former type of adhesives are commonly referred to as A-B adhesives, because the two surfaces (A and B) are treated differently, only one of the surfaces receiving a treatment of adhesive. The latter type of adhesives are commonly referred to as A-A adhesives, because the two surfaces (A and A) are treated the same, both surfaces receiving a treatment of adhesive.

Michem® Flex 4915 general purpose A-A heat seal coating for sealing aluminum foil or paper to itself is a suitable substance that may be coated on both of the two sheets of paper 500 and 502 to facilitate heat sealability of the papers 500 and 502. Michem® Flex 4915 A-A heat seal coating is available from Michelman, Inc. Suitable coatings may also be available from HS Manufacturing Group. Other suitable A-A or A-B adhesives or other suitable types of substances may be used instead or in addition.

### Method for Manufacturing a Garment Protection Material

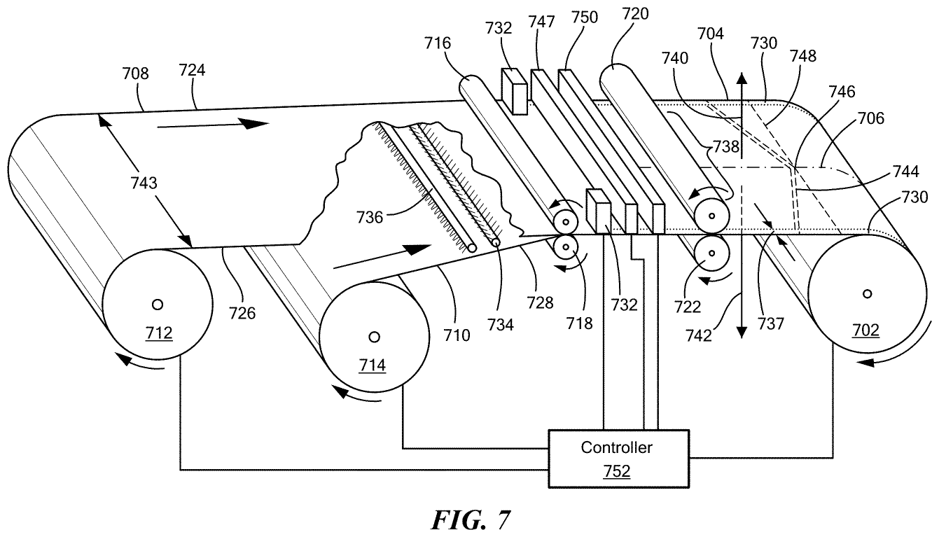

FIG. 7 is a perspective illustration of a method and apparatus 700 for manufacturing a roll 702 of product transport package material. The product transport package material may be used as a garment protection material 704. FIG. 8 is a plan view of, i.e. a view normal to a surface of, a portion of one embodiment of the garment protection material 704 manufactured by the method and apparatus 700. Individual paper-based garment bags, such as the garment bag 400 described with reference to FIGS. 4-6, may be made or cut from the garment protection material 704. The garment protection material 704 has a longitudinal axis 706, which winds on the roll 702.

With suitable modifications, examples of which are provided herein, the method and apparatus 700 may be used to manufacture rolls of product transport package material for other purposes, such as rolls of produce protection bags for use in grocery stores, or to protect and/or store any other product.

Using the garment protection material 704 as an example, two parallel coextensive elongated sheets of paper 708 and 710 are provided, such as from respective rolls 712 and 714 of paper. Each sheet of paper 708 and 710 is at least about 600 ft. (182.9 m) long 800, as measured parallel to the longitudinal axis 706. That is, each roll 712 and 714 may initially contain at least about 600 linear ft. (182.9 linear m) of paper. Movement of the two sheets of paper 708 and 710 through the method and apparatus 700, as well as rotation of the rolls 702, 712 and 714 and rollers 716, 718, 720 and 722 of the apparatus 700, are shown by respective arrows.

Each sheet of paper 708 and 710 has two side edges, represented by left and right side edges 724 and 726, respectively, of the top sheet of paper 708 and the right edge 728 of the bottom sheet of paper 710. The left edge of the bottom sheet of paper 710 is not visible in FIG. 7. The side edges 724-728 are parallel to the longitudinal axis 706.

The two sheets of paper 708 and 710 are joined together along the two side edges 724-728 by respective joints 730. As noted, the joints 730 may be formed by heat sealing the two sheets of paper 708 and 710 to each other. Alternatively, the two sheets of paper 708 and 710 may be joined by an adhesive. The heat sealed joints may be formed, or the adhesive may be activated, by heat, such as heat generated by respective ultrasonic or infrared heat sealers 732. A suitable ultrasonic sealer is available from Herrmann Ultrasonics (Herrmann Ultraschall), 1261 Hardt Circle, Bartlett, Ill. 60103, www.herrmannultrasonics.com. One or both of the two sheets of paper 708 and/or 710 may be pre-coated with a suitable heat sealer and/or adhesive, such as by a supplier of the rolls 712 and 714.

Alternatively or in addition, a suitable sealer or adhesive may be applied to one or both of the sheets of paper 708 and/or 710 as part of the method and apparatus 700, such as by spaying a suitable substance onto the sheet(s) of paper 708 and/or 710. One or two sprayers 734 and/or 736 may be configured to apply the heat sealer and/or adhesive onto the sheet(s) of paper 708 and/or 710. Although the sprayers 734 and 736 are shown applying a substance across the entire width of one side of each sheet of paper 708 and/or 710, one or both sprayers 734 and/or 736 may be configured to apply the substance to only a peripheral portion, such as about an outer ½ inch (12.7 mm), as exemplified at 737, of each sheet of paper 708 and/or 710. In some embodiments, the sprayers 734 and/or 736 are configured to apply the substance to a peripheral portion of each sheet of paper 708 and/or 710 and to periodically (along the longitudinal axis 706) apply the substance across the entire width of one side of one or both sheets of paper 708 and/or 710, to facilitate forming lateral joint lines 744, which are described herein.

Once the two sheets of paper 708 and 710 are joined together along the two side edges 724-728 along the joints 730, the two sheets of paper 708 and 710 define an expandable volume (not visible) between the two sheets of paper 708 and 710. Central portions, represented by central portion 738, of the two sheets of paper 708 and 710 are separable from each other, as indicated by arrows 740 and 742, to increase the volume between the two sheets of paper 708 and 710. The central portions 738 of the two sheets of paper 708 and 710 are separable from each other to accept an article of clothing hung on a clothes hanger (not shown, but along the lines described with reference to FIGS. 4-6).

Rollers 716-722 may be used to keep counterfacing surfaces of the two sheets of paper 708 and 710 in intimate contact with each other while the joint 730 forms, ex., a heat seal cools or an adhesive is activated, and, optionally, partially or fully cures. The two sheets of paper 708 and 710, now in the form of finished garment protection material 704, is wound lengthwise onto the roll 702.

Each of the two sheets of paper 708 and 710 may have a basis weight of about 20-45 GSM, although the two sheets of paper 708 and 710 need not necessarily have the same basis weight. Other suitable basis weight papers, i.e., less than 20 GSM and/or greater than 45 GSM, may be used. Each sheet of the two sheets of paper 708 and 710 may be between about 10 inches (25.4 cm) and about 40 in. (101.6 cm) wide 743, as measured perpendicular to the longitudinal axis 706.

Each sheet of paper 708 and/or 710 may include a recyclable paper.

At least one sheet of the two sheets of paper 708 and/or 710 may be coated with a substance configured to increase tensile and/or bursting strength of paper, and/or a substance configured to increase water resistance of paper, and/or a substance configured to increase translucency of paper, and/or a substance configured to facilitate heat sealability of paper. Both of the two sheets of paper 708 and 710 may be coated with a substance configured to facilitate heat sealability of paper.

The aforementioned HydraBan® 708 paper coating and/or Michem® Flex 4915 general purpose A-A heat seal coating and/or another suitable coating may be used, as discussed with respect to the garment bag 400. Any of these coatings, or any combination of these coatings, may be applied by the one or two sprayers 734 and/or 736, as discussed herein with respect to forming the joint 730 or other type of sealer onto the sheet(s) of paper 708 and/or 710. Optionally or alternatively, any of these coatings, or any combination of these coatings, may be applied by an additional one or more sprayers (not shown), similar to the sprayers 734 and/or 736, discussed herein. Optionally or alternatively, one or more of the substances may be applied by a roller or using printing technology.

Joining the two sheets of paper 708 and 710 together may include heat sealing the two sheets of paper 708 and 710 together. As noted, the adhesive 730 may be activated by heat, such as heat generated by respective ultrasonic or infrared heat sealers 732. Optionally or alternatively, contact adhesive may be use, which may obviate a need for heat activating the adhesive 730.

As described thus far, the method and apparatus 700 produce a flattened elongated tube of paper that is wound on the roll 702. This tube may be used to make individual garment bags 400, such as by using the garment bagger machine described with respect to FIG. 3, but substituting the paper-based garment protection material 704 for the polyethylene sleeve, i.e. substituting the roll 702 of paper-based garment protection material 704 for the roll 200 of polyethylene sleeve.

Optionally, the method and apparatus 700 may define individual garment bags 400 along the longitudinal axis 706 of the garment protection material 704, as illustrated in FIG. 8. In this embodiment, in addition to joining the two sheets of paper 708 and 710 along their side edges 724-728, the two sheets of paper 708 and 710 are also joined together by a heat seal or adhesive joint along respective lateral joints 744 that extend generally perpendicular to the longitudinal axis 706 and between the side edges 724-728. One or more additional ultrasonic or infrared heat sealers 747 may be used to form the joints 744 or heat activate adhesive.

The lateral joint lines 744 may be spaced apart periodically, along the longitudinal axis 706, as indicated at 802. Each lateral joint line 744 may have a center 746, and the joint of each lateral joint line 744 may define a gap 804 in the joint proximate the center 746 of the lateral joint line 744. The gap 804 may be configured for protrusion of a clothes hanger hook through the gap 804, as discussed with respect to the garment bag 400.

Each lateral joint line 744 need not be straight. For example, each lateral joint line 744 may include two non-collinear line segments that extend from the center 746 to respective side edges 724-728 at an angle of about 30° relative to a perpendicular to the longitudinal axis 706. In this context, as used herein, including in the claims, within about 45° of perpendicular to the longitudinal axis 706 is considered to be substantially perpendicular or generally perpendicular to the longitudinal axis 706.

Furthermore, optionally, for each lateral joint line 744, the two sheets of paper 708 and 710 may be perforated along a respective tear line 748 proximate the lateral joint line 744, such as within about 6 in. (15.24 cm) of the lateral joint line 744 and generally closer, i.e. within about 2 in. (5.08 cm). Each tear line 748 may extend generally perpendicular to the longitudinal axis 706, between the side edges 724-728. A perforator 750 may be used to form the tear lines 748. Perforating the two sheets of paper 708 and 710 may include spacing the tear lines 748 apart along the longitudinal axis 706 by about 10 inches (25.4 cm) to about 96 in. (243.84 cm), as indicated at 806.

Optionally, the two sheets of paper 708 and 710 may be perforated along additional tear lines 808 to define waste material 410 (also shown in FIG. 4). The waste material 410 may be removed, for example after a garment bag 400 has been installed over an article of clothing 402 and a clothes hanger 404. One or more additional perforators (not shown) may be used to form the additional tear lines 808.

A processor-based controller 752 may be configured to automatically: control and/or measure speeds of motors that operate the respective rolls 702, 712 and 714 and the rollers 716-722; measure speeds of travel of the two sheets of paper 708 and 710 and/or the garment protection material 704, for example using speed sensors (not shown); control operation of the substance applicators (sprayers, rollers and/or printers, etc.); control operation of the ultrasonic or infrared heat sealers 732; control operation of the additional ultrasonic or infrared heat sealers 747; and/or control operation of the perforator 750. The processor-based controller may execute instructions stored in a memory to perform the method described herein and control the apparatus described herein.

Thus, the method and apparatus 700 may produce a garment protection material 704, largely a flattened elongated tube of paper, that is wound on the roll 702 and that may be subsequently used with a garment bagger 300 (FIG. 3) to form individual garment bags 400. Optionally or alternatively, the method and apparatus 700 may produce a series of garment bags 400 that are connected to each other end-to-end, as shown in FIG. 8. Of course, the garment bags 400 of the series may be separated from each other along respective tear lines 748 to form individual garment bags 400. Optionally or alternatively, regardless whether the series of garment bags 400 has tear lines 748, the garment bags 400 of the series may be separated from each other by cutting to form individual garment bags 400. For example, the method and process 700 may include a knife or guillotine to cut individual bags 400 as they are formed, and these bags 400 may be stacked, in place of the roll 702.

### Garment Protection Material

As noted, the method and apparatus 700 described with reference to FIG. 7 may produce a garment protection material 704 that is wound on the roll 702. The garment protection material 704 has a longitudinal axis 706. The garment protection material 704 includes two parallel coextensive elongated sheets of paper 708 and 710. Each sheet of paper 708 and 710 is at least about 600 ft. (182.9 m) long 800, as measured parallel to the longitudinal axis 706. Each sheet of paper 708 and 710 has two side edges 724-728 parallel to the longitudinal axis 706. The two sheets of paper 708 and 710 are joined together along the two side edges 724-728 by an adhesive 730. The two sheets of paper 708 and 710 define an expandable volume between the two sheets of paper 708 and 710. Central portions 738 of the two sheets of paper 708-710 are separable 740-742 from each other to increase the volume between the two sheets of paper 708-710, such as to accept an article of clothing 402 hung on a clothes hanger 404. The two sheets of paper 708-710 are wound lengthwise into a roll 702.

### Method for Manufacturing a Garment Protection Material

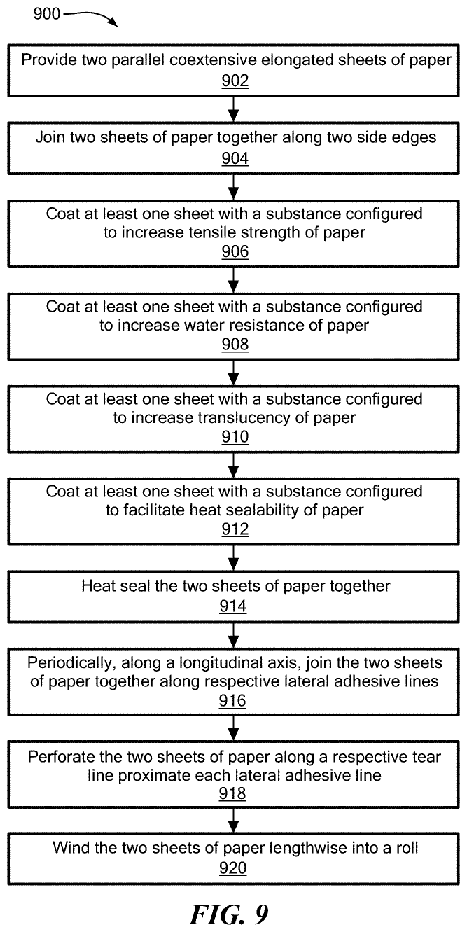

FIG. 9 is a flowchart schematically illustrating a method 900 for manufacturing the garment protection material 704, according to an embodiment of the present invention. The method 900 corresponds to the method 700 illustrated in FIG. 7. As noted, the garment protection material 704 has a longitudinal axis 706.

At 902, two parallel coextensive elongated sheets 708 and 710 of paper are provided. Each sheet of paper 708 and 710 is at least about 600 ft. (182.9 m) long 800, as measured parallel to the longitudinal axis 706. Each sheet of paper 708 and 710 has two side edges 724-728 parallel to the longitudinal axis 706.

At 904, the two sheets of paper 708 and 710 are joined together along the two side edges 724-728 along respective joints. The two sheets of paper 708 and 710 then define an expandable volume therebetween. Central portions 738 of the two sheets of paper 708 and 710 are separable 740, 742 from each other to increase the volume between the two sheets of paper 708 and 710, such as to accept an article of clothing hung on a clothes hanger.

Optionally, at 906, at least one sheet 708 and/or 710 of the two sheets of paper is coated with a substance configured to increase tensile and/or burst strength of paper.

Optionally, at 908, at least one sheet 708 and/or 710 of the two sheets of paper is coated with a substance configured to increase water resistance of paper.

Optionally, at 910, at least one sheet 708 and/or 710 of the two sheets of paper is coated with a substance configured to increase translucency of paper.

Optionally, at 912, at least one sheet 708 and/or 710 of the two sheets of paper is coated with a substance configured to facilitate heat sealability of paper.

Optionally, at 914, the two sheets of paper 708 and 710 are heat sealed and/or adhered together.

Optionally, at 916, the two sheets of paper 708 and 710 are periodically, along the longitudinal axis, joined together along respective lateral joint lines 744 extending generally perpendicular to the longitudinal axis 706 and between the side edges 724-728. Each lateral joint line 744 has a respective center 746, and the joint defines a gap 804 in the joint proximate the center 746 of the lateral joint line 744. The gap 804 is configured for protrusion of a clothes hanger hook through the gap 804.

Optionally, each lateral joint line 744 may extend along two respective lines that are symmetric about the longitudinal axis 706, as viewed normal to the two sheets of paper. Each line extends substantially from the center 746 of the lateral joint line 744 to a respective different one of the side edges 724-728 and slopes from the center 746 of the lateral joint line 744 toward an end of the two sheets of paper 708 and 710.

Optionally, at 918, for each lateral joint line 744, the two sheets of paper 708 and 710 are perforated along a respective tear line 748 proximate the lateral adhesive line 744. The tear line 748 extends generally perpendicular to the longitudinal axis 706 and between the side edges 724-728.

The tear lines 748 may be spaced apart along the longitudinal axis 706 by about 10 inches (25.4 cm) to about 96 in. (243.84 cm).

At 920, the two sheets of paper 708 and 710 are wound lengthwise into a roll 702.

Alternatively, rather than using two sheets of paper 708 and 710, a single sheet of paper may be folded along a line parallel to the longitudinal axis 706, and the two side edges of the single sheet of paper may be joined together, such as by a heat seal joint or an adhesive. In other respect, this embodiment is similar to the garment bag embodiments described herein, and it may be made by a method and apparatus similar to the method and apparatus described herein.

### Produce Protection Material

Currently, grocery stores commonly provide rolls of plastic bags. Shoppers tear off individual bags and collect produce, baked goods, etc. in the bags, prior to paying for the groceries upon checkout. A method and apparatus similar to those described with respect to FIGS. 7-9 may be used to fabricate a continuous roll of product transport package material 1004, such as paper bags sized similar to conventional grocery store plastic bags, and these rolls may be used in stores to replace the plastic bag rolls in use today. FIG. 1000 is a plan view of a portion of one embodiment of the product transportation material 1004 manufactured by the method and apparatus. Individual paper-based produce (or other product) bags may be made or cut from the product transportation package material 1004. The product transportation package material 1004 has a longitudinal axis 706, which winds on a roll, such as roll 702 (FIG. 7).

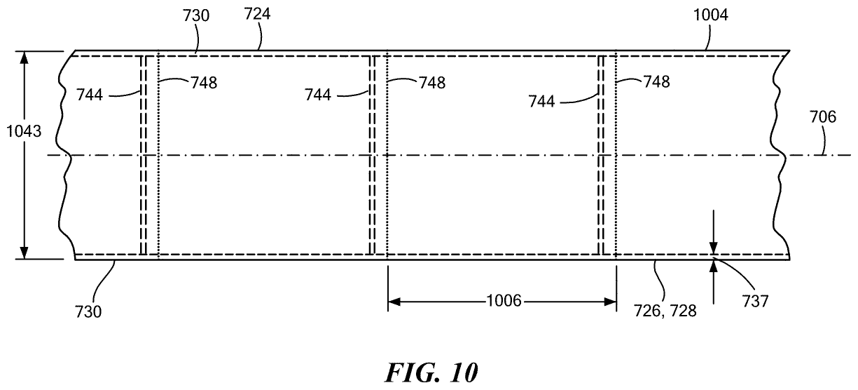

The lateral joint lines 744 in FIG. 10 may be perpendicular to the longitudinal axis 706, and they may define no gap, in contrast to the garment protection material 704 of FIGS. 7-9. Tear lines 748 are longitudinally spaced apart a distance 1006, such as about 10-40 inches (25.4-101.6 cm) suitable for a desired depth of the bags. Width 1043 of the product transportation package material 1004 depends on a desired width of the bags, such as about 6-18 inches (15.2-45.7 cm). In other respects, the product transportation package material 1004 of FIG. 1000 is similar to the garment protection material 704 of FIGS. 7-9.

Because grocery stores typically require smaller rolls of produce bags, smaller rolls of the product transport package material 1004 may be spooled from the roll 702 (FIG. 7).

### Other Shapes

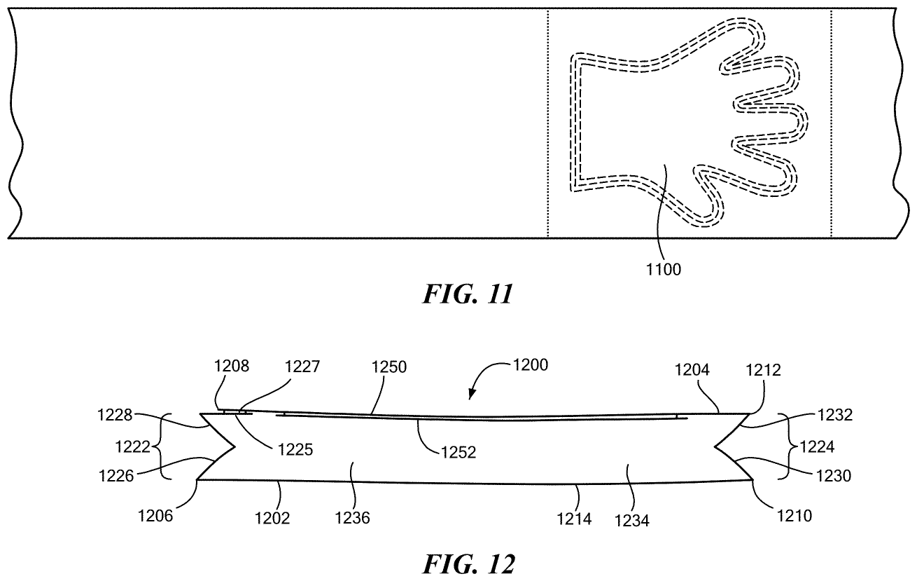

Other shaped containers may be made by apparatus and methods similar to those described with respect to FIGS. 7-10. For example, as shown in FIG. 11, paper gloves may be made, exemplified by paper glove 1100. Such gloves find utility at gasoline filling stations, where customers may tear off one or two gloves for use while refueling their vehicles.

### Garment Transport and Other Product Packages

Embodiments of the present invention also provide an environmentally-friendly alternative to polyethylene garment and other product transport packages. A product transport package according to embodiments of the present invention is made of paper, which can be recycled, re-pulped and/or composted. Unlike plastic, paper has a single recycle stream and is, therefore, easier for consumers to properly recycle. Furthermore, paper is made from a renewable resource (wood pulp), in contrast with polyethylene, which is made from petroleum. Described herein are individual paper-based product transport packages and methods and apparatus for manufacturing the paper-based product transport packages.

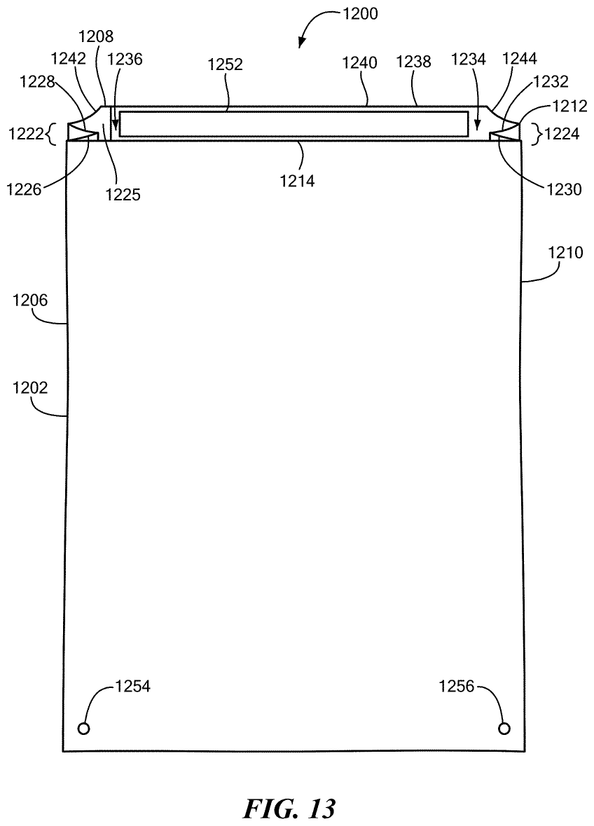

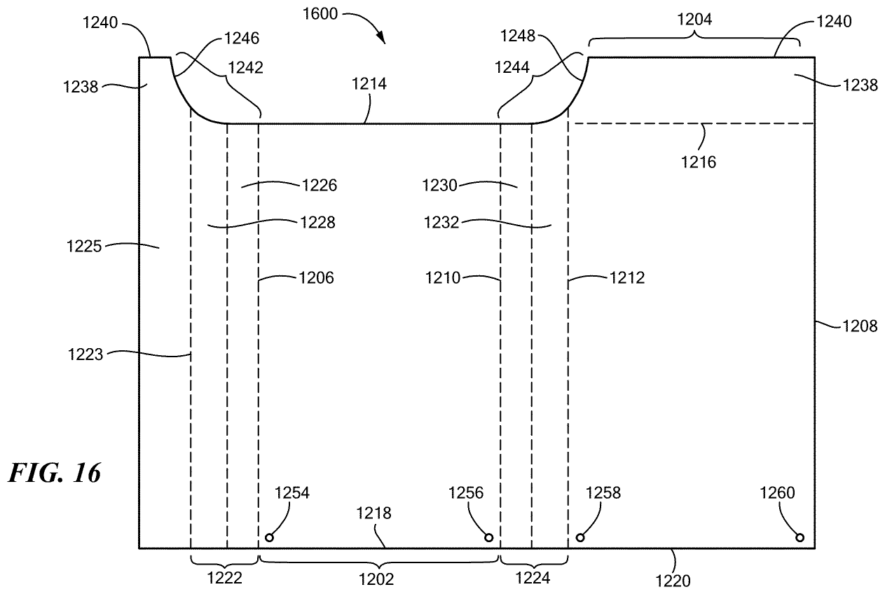

FIGS. 12, 13, 14 and 15 are respective top, front, side and front perspective views of a paper-based product transport package 1200, according to an embodiment of the present invention. The paper-based product transport package 1200 has the general shape of a gusseted envelope. Embodiments without gussets are also contemplated. The paper-based product transport package 1200 can, but need not necessarily, be made of a single sheet of appropriately cut and folded paper 1600 shown in FIG. 16. The paper-based product transport package 1200 includes a first rectangular sheet 1202 and a second rectangular sheet 1204. The second sheet 1204 is parallel and co-extensive with the first sheet 1202.

As used herein, the term “edge” means an outer boundary of a material. No material extends beyond the edge. As used herein, the term “margin” means an edge or a boundary between two parts of a material. Thus, a margin can, but need not, be an edge.

As used herein, “coextensive” means the two sheets 1202 and 1204 have substantially the same width and length dimensions, within their respective margins or edges, and one of the sheets 1202 registers above the other sheet 1204, as viewed normal to the paper-based garment transport package 1200.

Each sheet 1202 and 1204 has a respective first longitudinal margin 1206 and 1208 (best seen in FIG. 16). Each sheet 1202 and 1204 also has a respective second longitudinal margin 1210 and 1212 (also best seen in FIG. 16). Each second longitudinal margin 1210 and 1212 is opposite the respective first longitudinal margin 1206 and 1208. That is, each second longitudinal margin 1210 and 1212 is on the opposite side of the sheet 1202 or 1204 from the respective first longitudinal margin 1206 and 1208 of that sheet 1202 or 1204.

Each sheet 1202 and 1204 has a respective first lateral margin 1214 and 1216. Each sheet 1202 and 1204 also has a respective second lateral margin 1218 and 1220. Each second lateral margin 1218 and 1220 is opposite the respective first lateral margin 1214 and 1216. That is, each second lateral margin 1218 and 1220 is on the opposite side of the sheet 1202 or 1204 from the respective first lateral margin 1214 and 1216 of that sheet 1202 or 1204.

The two sheets 1202 and 1204 are joined to each other along their respective first longitudinal margins 1206 and 1208 by a first paper gusset 1222. The two sheets 1202 and 1204 are also joined to each other along their respective second longitudinal margins 1210 and 1212 by a second paper gusset 1224. As noted, the two sheets 1202 and 1204 and the two gussets 1222 and 1224 may all be parts of a single sheet of paper 1600 (FIG. 16).

In embodiments that lack gussets, the material 1222 and 1224 is absent. That is, longitudinal margin 1210 coincides with longitudinal margin 1212, and longitudinal margins 1206 coincides with dashed line 1223.

In embodiments that include gussets 1222 and 1224, the first paper gusset 1222 includes an extension 1225 (part of a flap, which is described below). The extension 1225 is joined to the second sheet 1204, such as by an adhesive 1227, heat seal, crimp or other suitable fastener.

One or both sheets 1202 and/or 1204 may be coated with a substance configured to facilitate heat sealability of paper, translucency of paper, strength of paper and/or water resistance of paper. Some adhesives are suitable when applied to only one of two surfaces that are to be joined to each other, while other adhesives work best when applied to both surfaces. The former type of adhesives are commonly referred to as A-B adhesives, because the two surfaces (A and B) are treated differently, only one of the surfaces receiving a treatment of adhesive. The latter type of adhesives are commonly referred to as A-A adhesives, because the two surfaces (A and A) are treated the same, both surfaces receiving a treatment of adhesive.

Michem® Flex 4915 general purpose A-A heat seal coating for sealing aluminum foil or paper to itself is a suitable substance that may be coated on both one or both of the two sheets 1202 and/or 1204 to facilitate heat sealability of the sheets 1202 and 1204. Michem® Flex 4915 A-A heat seal coating is available from Michelman, Inc. Suitable coatings may also be available from HS Manufacturing Group. Other suitable A-A or A-B adhesives or other suitable types of substances may be used instead or in addition.

Each paper gusset 1222 and 1224 includes at least two alternatingly folded pleat panels, exemplified by pleat panels 1226, 1228, 1230 and 1232, respectively. One of the at least two pleat panels 1226 and 1230 is attached to one of the two sheets 1202, and the other of the at least two pleat panels 1228 and 1232 is attached to the other of the two sheets 1204.

Although the embodiment shown in FIGS. 12-16 includes two folded pleat panels 1226-1232 per paper guest 1222 and 1224, other embodiments can include other numbers of pleat panels 1226-1232 per paper gusset 1222 and 1224, such as three, four, five, six, seven, eight or more pleat panels 1226-1232 per paper gusset 1222 or 1224.

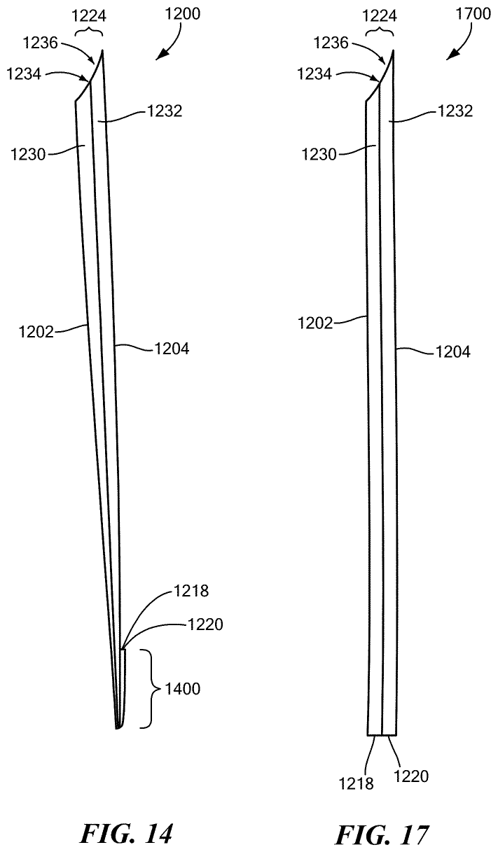

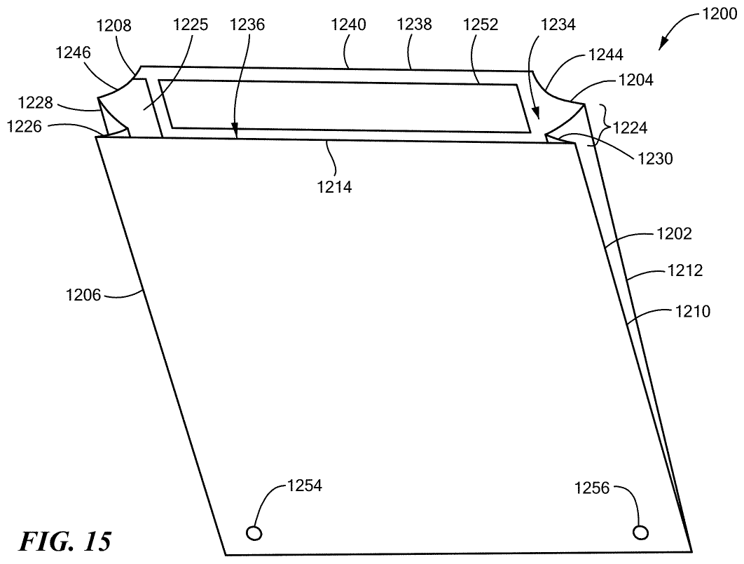

The two sheets 1202 and 1204 are further joined to each other along their respective second lateral margins 1218 and 1220. As shown in FIG. 14, a portion 1400 of the first and second sheets 1202 and 1204 may be folded and secured to one of the two sheets 1202 or 1204, such as by an adhesive, heat seal, crimp or other suitable fastener. Alternatively, the portion 1400 of the first and second sheets 1202 and 1204 may be secured to one of the two sheets 1202 or 1204, without folding, such as by a heat seal. In the embodiment shown in FIGS. 14 and 15, the paper-based product transport package 1200 tapers to become narrower proximate the second lateral margins 1218 and 1220.

Alternatively, as show in FIG. 17, the two sheets 1202 and 1204 may be joined to each other to form a box bottom of a paper-based garment transport package 1700.

In either case, the two sheets 1202 and 1204 and the gussets 1222 and 1224 thereby define an interior volume 1234 therebetween. The two sheets 1202 and 1204 and the gussets 1222 and 1224 thereby also define an opening 1236. The opening 1236 extends along the first lateral margins 1214 and 1216. The opening 1236 is in communication with the interior volume 1234. Garments, such as a shirt, may be inserted into, and retrieved from, the interior volume 1234, via the opening 1236.

A flap 1238 extends from the first lateral margin 1216 of the second sheet 1204 to a lateral edge 1240 of the flap 1238. The lateral edge 1240 is distal from the first lateral margin 1216 of the second sheet 1204. The flap 1238 is coplanar with the second sheet 1204.

The flap 1238 defines two laterally spaced-apart shoulders 1242 and 1244. The lateral edge 1240 of the flap 1238 extends between the shoulders 1242 and 1244. Each shoulder 1242 and 1244 extends along a respective smoothly-curved line 1246 and 1248 that extends tangent from the first lateral margin 1214 of the first sheet 1202 to the lateral edge 1240 of the flap 1238. As used herein, a smoothly-curved line is a line defined by a function that has continuous derivatives between end points of the line. Thus, there is no corner along either shoulder 1242 or 1244 or where the shoulder 1242 or 1244 meets the first lateral margin 1214 of the first sheet 1202. This smoothness of the lines 1246 and 1248 prevent pressure points, which might otherwise stress the material of the paper-based product transport package 1200, such as when a garment or other product is inserted into, or removed from, the interior volume 1234.

Each smoothly-curved line 1246 and/or 1248 may be concave, as viewed along the first lateral margin 1214 of the first sheet 1202 from the other smoothly-curved line 1248 and/or 1246.

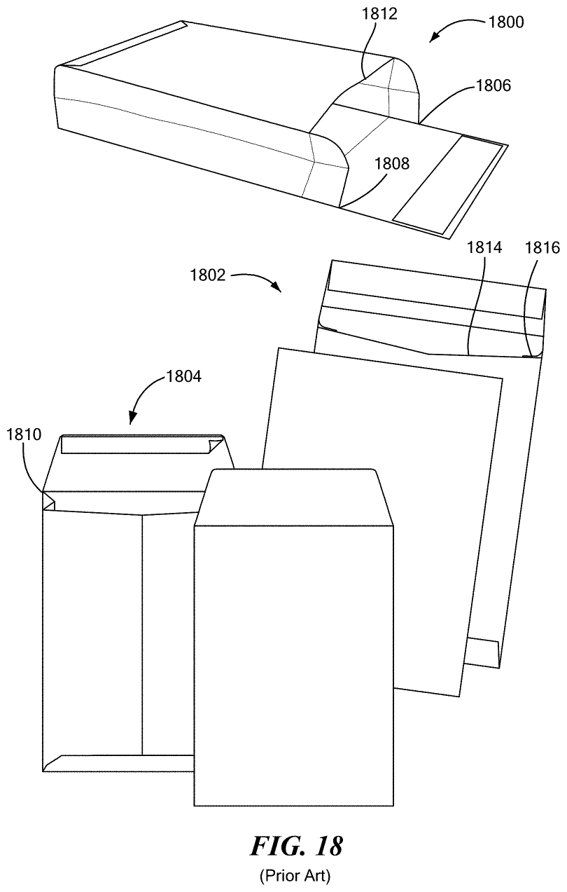

In contrast, prior art envelopes have shoulders that do not extend along smoothly-curved lines. FIG. 18 illustrates three prior art envelopes 1800, 1802 and 1804. Each of these envelopes 1800-1804 has a shoulder that includes a corner 1806, 1808, 1810, or joins a lateral margin 1812 or 1814 at a corner 1816. As noted, such corners create stress points, which may lead to tearing of the material of the envelopes.

The two sheets 1202 and 1204, the first and second gussets 1222 and 1224 and the flap 1238 may be formed from a single continuous sheet 1600 (FIG. 16) of paper folded to form the first and second gussets 1222-1224 and to dispose the two sheets 1202 and 1204 parallel and co-extensive each other.

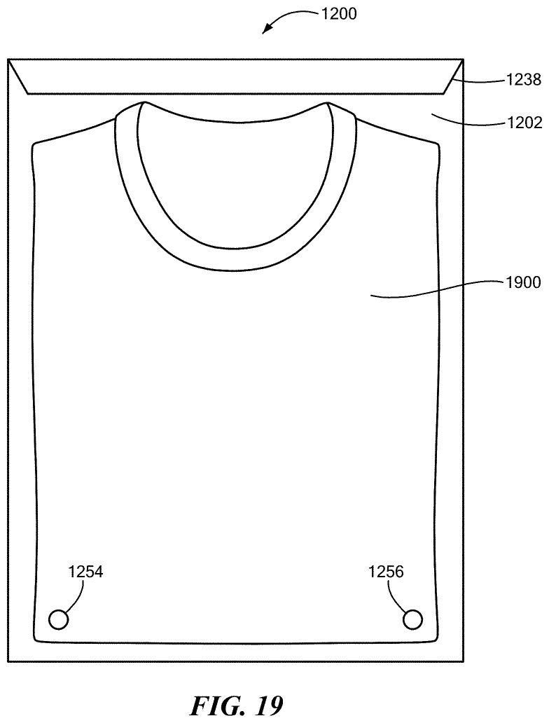

Returning to FIGS. 12-16, a re-sealable, pressure-sensitive, compostable, recyclable and/or re-pulpable, adhesive 1250 is disposed on the flap 1238, and a paper release strip 1252 is attached to the flap 1238 by the adhesive 1250. After a garment has been inserted into the interior volume 1234, the release strip 1252 may be removed, the flap 1238 may be folded 180°, and the flap may be adhered to the first sheet 1202 by the adhesive 1250. FIG. 19 illustrates an exemplary use of the paper-based product transport package 1200. In FIG. 19, a shirt 1900 is disposed inside the paper-based product transport package 1200, and the flap 1238 is folded over and adhered to the first sheet 1202.

To facilitate visually observing a garment disposed in the paper-based product transport package 1200, at least one of the first and second sheets 1202 and/or 1204 is glassine treated with a substance configured to increase translucency of the material, although other suitable papers may be used. The glassine may have a basis weight between about 20 GSM and about 60 GSM, although other basis weights may be used. The substance configured to increase translucency of the glassine may include at least about 75% plant-based product.

Glassine is a smooth and glossy paper that is air, water, and grease resistant. Glassine is usually available in densities between about 20-90 g/m² (GSM). Glassine is translucent, unless dyes are added to color it or make it opaque. Glassine is manufactured by supercalendering. After pressing and drying, paper web is passed through a stack of alternating steel- and fiber-covered rolls called a supercalender at the end of a paper machine, such that the paper fibers flatten facing in the same direction. As noted, glassine without dyes is translucent. However, glassine is not inherently transparent.

As used herein, transparency is a physical property that allows visible light to pass through a material without being scattered. Visible light has a wavelength between about 400 nm and about 700 nm. On a macroscopic scale, i.e., where dimensions being investigated are much larger than the wavelength of photons in question, the photons can be said to follow Snell's Law. Translucency allows light to pass through, but does not necessarily, on the macroscopic scale, follow Snell's law. The photons can be scattered at either of two interfaces of the material, or internally, where there is a change in index of refraction. In other words, a translucent material is made up of components with different indices of refraction.

On the other hand, a transparent material is made up of components with a uniform index of refraction. Transparent materials appear clear, with an overall appearance of one color, or any combination of colors. The opposite property of translucency is opacity. As a practical matter, all materials contain impurities that prevent the materials being 100% transparent. However, as used herein, transparent means transparent for practical purposes. For example, a sheet of ⅛-inch (3.175 mm) thick glass is deemed to be transparent.

To many people, the boundary between transparent and translucent is subjective. However, a degree of light transmission may be measured using ASTM D-1003 (Standard Test Method for Haze and Luminous Transmittance of Transparent Plastics, available from ASTM International, 100 Barr Harbor Drive, PO Box C700, West Conshohocken, Pa., 19428-2959). This test method is used to evaluate light transmission and scattering of transparent plastics for a defined specimen thickness. As a general rule, light transmission percentages over 85 are considered to be “transparent.”

As used herein, the phrase “increase transparency” or “increase translucency” means altering a material to increases light transmission percentage by at least about 5%, such as measured by ASTM D-1003 or another suitable technique. Increasing transparency or translucency of a material causes the material to scatter light less than before the alteration.

The opacity of untreated glassine is about o. 186 (opacity contrast 10-16% (ISO 2471)).

HydraBan® 708 paper coating is a suitable re-pulpable substance that may be coated on one or both of the two sheets 1202 and/or 1204 to increase strength, water resistance, translucency and/or transparency of the sheet. HydraBan® 708 paper coating is available from Michelman, Inc., 9080 Shell Road, Cincinnati, Ohio 45236-1299 USA, www.michelman.com. Suitable coatings may also be available from HS Manufacturing Group, 41 Madison Avenue, 31st Floor, New York, N.Y. 10010, www.hsmgrp.com. Other suitable substances may be used instead or in addition. Once coated with a suitable coating, the paper of the two sheets 1202 and 1204 may transmit about 65-85% of incident light.

At least one of the two sheets 1202 and/or 1204 defines a respective hole, represented by holes 1254, 1256, 1258 and 1260, through the respective sheet 1202 and/or 1204. Each hole 1254-1260 is proximate a corner of the sheet 1202 or 1204 bounded by the second lateral margin 1218 or 1220 and either the first or the second longitudinal margin 1206, 1208, 1210 or 1212, as the case may be.

The two sheets 1202 and 1204, the first and second paper gussets 1222 and 1224 and the flap 1238 may be made of a compostable material, a recyclable material, a re-pulpable material and/or at least 50% post-consumer recycled content derived from wood pulp.

Optionally, in any embodiment, at least one sheet of the two sheets may be coated with a substance configured to increase burst strength of paper, increase water resistance of paper, increase translucency of paper and/or facilitate heat sealability of paper.

The paper-based product transport package 1200 may be made using a method and apparatus similar to that described with respect to FIGS. 7-9, with suitable modifications. For example, an additional supply roll may provide the adhesive 1250 and the paper release strip 1252.

Thus, in general, embodiments of the present invention provide individual paper-based packages or rolls of continuous paper-based packages or rolls of material that can be used to make individual paper-based packages, such as with the machine of FIG. 3. Other embodiments provide methods and apparatus for manufacturing the same. Joints between sheets of paper in any of these embodiments may be made by heat sealing the sheets to each other or using an adhesive. In all embodiments, the paper is coated with a substance to increase translucency of the paper. Optionally, the paper may be coated with a substance or combination of substances to increase heat sealability, strength and/or water resistance of the paper.

While the invention is described through the above-described exemplary embodiments, modifications to, and variations of, the illustrated embodiments may be made without departing from the inventive concepts disclosed herein. For example, although specific parameter values, such as dimensions and materials, may be recited in relation to disclosed embodiments, within the scope of the invention, the values of all parameters may vary over wide ranges to suit different applications. Unless otherwise indicated in context, or would be understood by one of ordinary skill in the art, terms such as “about” mean within ±20%.

As used herein, including in the claims, the term “and/or,” used in connection with a list of items, means one or more of the items in the list, i.e., at least one of the items in the list, but not necessarily all the items in the list. As used herein, including in the claims, the term “or,” used in connection with a list of items, means one or more of the items in the list, i.e., at least one of the items in the list, but not necessarily all the items in the list. “Or” does not mean “exclusive or.”

Although aspects of embodiments may be described with reference to flowcharts and/or block diagrams, functions, operations, decisions, etc. of all or a portion of each block, or a combination of blocks, may be combined, separated into separate operations or performed in other orders. References to a “module” are for convenience and not intended to limit its implementation. All or a portion of each block, module or combination thereof may be implemented as computer program instructions (such as software), hardware (such as combinatorial logic, Application Specific Integrated Circuits (ASICs), Field-Programmable Gate Arrays (FPGAs), processor or other hardware), firmware or combinations thereof.

The controller 752, or portions thereof, may be implemented by one or more processors executing, or controlled by, instructions stored in a memory. Each processor may be a general purpose processor, such as a central processing unit (CPU), a graphic processing unit (GPU), digital signal processor (DSP), a special purpose processor, etc., as appropriate, or combination thereof.

The memory may be random access memory (RAM), read-only memory (ROM), flash memory or any other memory, or combination thereof, suitable for storing control software or other instructions and data. Instructions defining the functions of the present invention may be delivered to a processor in many forms, including, but not limited to, information permanently stored on tangible non-transitory non-writable storage media (e.g., read-only memory devices within a computer, such as ROM, or devices readable by a computer I/O attachment, such as CD-ROM or DVD disks), information alterably stored on tangible non-transitory writable storage media (e.g., floppy disks, removable flash memory and hard drives) or information conveyed to a computer through a communication medium, including wired or wireless computer networks. Moreover, while embodiments may be described in connection with various illustrative data structures, systems may be embodied using a variety of data structures.

Disclosed aspects, or portions thereof, may be combined in ways not listed above and/or not explicitly claimed. In addition, embodiments disclosed herein may be suitably practiced, absent any element that is not specifically disclosed herein. Accordingly, the invention should not be viewed as being limited to the disclosed embodiments.

As used herein, numerical terms, such as “first,” “second” and “third,” are used to distinguish respective sheets, gussets, folds, panels, etc. from one another and are not intended to indicate any particular order or total number of sheets, gussets, folds, panels, etc. in any particular embodiment. Thus, for example, a given embodiment may include only a second panel and a third panel.

What is claimed is:

1. A product transport package, comprising:
a first rectangular sheet and a second rectangular sheet parallel and co-extensive with the first sheet, each sheet comprising paper treated with a substance configured to increase translucency of the paper, each sheet having: (a) a first longitudinal margin, (b) a second longitudinal margin opposite the first longitudinal margin, (c) a first lateral margin and (d) a second lateral margin opposite the first lateral margin, the two sheets being joined to each other along their respective first and second longitudinal margins by respective first and second joints, the two sheets being further joined to each other along their respective second lateral margins by a third joint, the two sheets and the first, second and third joints thereby defining an interior volume therebetween and an opening, along the first lateral margins, into the interior volume;
a paper flap coplanar with, and extending from the first lateral margin of, the second sheet to a lateral edge of the flap, distal from the first lateral margin of the second sheet, wherein: (a) the flap defines two laterally spaced-apart shoulders, (b) the lateral edge of the flap extends between the shoulders and (c) each shoulder extends along a respective smoothly-curved line extending tangent from the first lateral margin of the first sheet to the lateral edge of the flap;
a re-sealable, pressure-sensitive adhesive disposed on the flap; and
a paper release strip attached to the flap by the adhesive disposed on the flap;
wherein the entire product transport package is recyclable in a conventional paper recycling process.

2. A transport package according to claim 1, wherein the first, second and third joints each comprises a respective heat seal joint.

3. A transport package according to claim 2, wherein first and second sheets comprise paper treated with a substance configured to increase heat sealability of the paper.

4. A transport package according to claim 1, wherein the first, second and third joints each comprises are respective adhesive joint.

5. A transport package according to claim 1, wherein the first and second sheets comprise paper treated with a substance configured to increase water resistance of the paper.

6. A transport package according to claim 1, wherein the first and second sheets comprise paper treated with a substance configured to increase strength of the paper.

7. A transport package according to claim 1, wherein each of the first and second sheets transmits at least about 65-85% of incident light.

8. A transport package according to claim 1, wherein the substance configured to increase translucency of the paper comprises at least 75% plant-based product.

9. A transport package according to claim 1, wherein each of the first and second sheets has a basis weight between about 20 GSM and about 60 GSM.

10. A transport package according to claim 9, wherein each of the first and second sheets comprises glassine.

11. A transport package according to claim 1, wherein at least one of the two sheets defines a respective hole therethrough proximate a corner of the sheet bounded by the second lateral margin and either the first or the second longitudinal margin, the hole defining a ventilation port between the interior volume and an exterior of the transport package.

12. A transport package according to claim 1, wherein at least one of the first, second and third joints defines a gap therein of at least about ¼ inch (6.35 mm), the gap defining a ventilation port between the interior volume and an exterior of the transport package.

13. A transport package according to claim 1, wherein each smoothly-curved line is concave, as viewed along the first lateral margin of the first sheet from the other smoothly-curved line.

14. A transport package according to claim 1, wherein each joint comprises a respective paper gusset, and each gusset comprises at least two alternatingly folded pleat panels, one of the two pleat panels being attached to one of the two sheets, and the other of the two pleat panels being attached to the other of the two sheets.

15. A transport package according to claim 14, wherein the two sheets, each gusset and the flap are formed from a single continuous sheet of paper folded to form the gussets and to dispose the two sheets parallel and co-extensive each other.

16. A transport package according to claim 1, wherein the entire product transport package comprises compostable material.

17. A transport package according to claim 1, wherein the entire product transport package comprises re-pulpable material.

18. A transport package according to claim 1, wherein each joint comprises a respective paper gusset, and the two sheets, the gussets and the flap each comprises at least 50% post-consumer recycled content derived from wood pulp.

19. A transport package according to claim 1, wherein each joint comprises a respective paper gusset, and the two sheets, the gussets and the flap each comprises glassine having a basis weight between about 20 GSM and about 60 GSM.

20. A garment bag having a longitudinal axis, the garment bag comprising:
two parallel coextensive elongated sheets of paper, each sheet comprising paper treated with a substance configured to increase translucency of the paper, each sheet of paper having two side edges parallel to the longitudinal axis, a bottom edge perpendicular to the longitudinal axis and a top edge, the top edge having a center, the two sheets of paper being joined together along the two side edges and along the top edge by respective joints, one of the joints defining a gap therein proximate the center of the top edge, the gap being configured for protrusion of a clothes hanger hook therethrough, the two sheets of paper defining an expandable volume therebetween, wherein central portions of the two sheets of paper are separable from each other to increase the volume therebetween to accept an article of clothing hung on a clothes hanger, wherein the entire garment bag is recyclable in a conventional paper recycling process.

21. A garment bag according to claim 20, wherein each joint comprises a respective heat seal joint.

22. A garment bag according to claim 21, wherein each sheet comprising paper treated with a substance configured to increase heat sealability of the paper.

23. A garment bag according to claim 20, wherein each joint comprises a respective adhesive joint.

24. A garment bag according to claim 20 wherein, for each sheet of the two sheets of paper, the top edge is substantially defined by two lines that are symmetric about the longitudinal axis, as viewed normal to the two sheets of paper, each line extending substantially from the center of the top edge to a respective different one of the side edges and sloping from the center of the top edge toward the bottom edge.

25. A garment bag according to claim 20, wherein each sheet of the two sheets of paper is between about 10 in. (25.4 cm) and about 40 in. (101.6 cm) wide, as measured perpendicular to the longitudinal axis, and between about 10 in. (25.4 cm) and about 96 in. (243.84 cm) long, as measured parallel to the longitudinal axis.

26. A garment bag according to claim 20, wherein each sheet of paper comprises a recyclable paper.

27. A garment bag according to claim 20, wherein at least one sheet of the two sheets of paper is coated with a substance configured to increase strength of paper.

28. A garment bag according to claim 20, wherein at least one sheet of the two sheets of paper is coated with a substance configured to increase water resistance of paper.

29. A garment bag according to claim 20, wherein at least one sheet of the two sheets of paper is coated with a substance configured to facilitate heat sealability of paper.

30. A garment bag according to claim 20, wherein each sheet of the two sheets of paper is coated with a substance configured to facilitate heat sealability of paper.

31. A garment bag according to claim 1, wherein each sheet of the two sheets of paper has a basis weight of about 20-45 GSM.

32. A product protection material having a longitudinal axis, the product protection material comprising:
two parallel coextensive elongated sheets of paper, each sheet of paper comprising paper treated with a substance configured to increase translucency of the paper, each sheet of paper being at least about 600 ft. (182.9 m) long, as measured parallel to the longitudinal axis, and having two side edges parallel to the longitudinal axis, the two sheets of paper being joined together along the two side edges by respective joints, the two sheets of paper defining an expandable volume therebetween, wherein central portions of the two sheets of paper are separable from each other to increase the volume therebetween to accept a product, the two sheets of paper being wound lengthwise into a roll.

33. A product protection material according to claim 32, wherein each sheet of the two sheets of paper is between about 10 inches (25.4 cm) and about 40 inches (101.6 cm) wide, as measured perpendicular to the longitudinal axis.

34. A product protection material according to claim 32, wherein, periodically along the longitudinal axis, the two sheets of paper are joined together along a respective lateral joint line extending generally perpendicular to the longitudinal axis and between the side edges.

35. A product protection material according to claim 34, wherein the lateral joint line has a center, the joint defines a gap therein proximate the center of the lateral joint line, and the gap is configured for protrusion of a clothes hanger hook therethrough.

36. A product protection material according to claim 34, wherein each lateral joint line extends along two respective lines that are symmetric about the longitudinal axis, as viewed normal to the two sheets of paper, each line extending substantially from the center of the lateral joint line to a respective different one of the side edges and sloping from the center of the joint adhesive line toward an end of the two sheets of paper.

37. A product protection material according to claim 34, wherein, for each lateral joint line, the two sheets of paper are perforated along a respective tear line proximate the lateral joint line, the tear line extending generally perpendicular to the longitudinal axis and between the side edges.

38. A product protection material according to claim 37, wherein the tear lines are spaced apart along the longitudinal axis by about 10 inches (25.4 cm) to about 96 in. (243.84 cm).

39. A method for manufacturing a product protection material having a longitudinal axis, the method comprising:
providing two parallel coextensive elongated sheets of paper, each sheet of paper comprising paper treated with a substance configured to increase translucency of the paper, each sheet of paper being at least about 600 ft. (182.9 m) long, as measured parallel to the longitudinal axis, and having two side edges parallel to the longitudinal axis;
joining the two sheets of paper together along the two side edges by respective joints, such that the two sheets of paper define an expandable volume therebetween, wherein central portions of the two sheets of paper are separable from each other to increase the volume therebetween to accept a product; and
winding the two sheets of paper lengthwise into a roll.
